(19) United States
(12) Patent Application Publication
(10) Pub. No.: US 2009/0041437 A1
(43) Pub. Date: Feb. 12, 2009

(54) PORTABLE MEDIA PLAYER

(75) Inventor: Carlton Calvin, Cerritos, CA (US)

Correspondence Address: BROWDY AND NEIMARK, P.L.L.C.;624 NINTH STREET, NW, SUITE 300, WASHINGTON, DC, 20001-5303, US

(73) Assignee: RAZOR USA LLC, Cerritos, CA (US)

(21) Appl. No.: 11/834,383

(22) Filed: Aug. 6, 2007

(51) Int. Cl. H04N 9/82

(52) U.S. Cl. 386/126

(57) ABSTRACT

A portable media player includes a media playing device, such as a tablet personal computer, a digital picture frame, a portable DVD player or a portable television, and a bag containing a plurality of granular objects therein and supporting the media playing device. Adjusting the distribution of the granular objects in the bag makes the bag deformable. By means of the profile deformable bag, the media playing device can be conveniently placed in an inclined posture suitable for viewing by its user.

### BACKGROUND OF THE INVENTION

1. Field of the Invention

The present invention relates generally to a digital media player and more specifically, to a portable media player, which can be conveniently adjusted to an inclined posture suitable for viewing by its user.

2. Description of the Related Art

A portable media player is widely used in modern life to play digital images or multimedia files. Since the portable media player has normally a plate-like shape, light weight and small size, the user can conveniently carry it to any place and watch the digital static/dynamic images played by the media player for amusement at any time.

However, the conventional portable media player is generally equipped with a fixed screen without angle-adjustable function. When the user sits down and places the media player on his/her thighs, the user needs to hold the media player with his/her hand all the time so as to keep the media player in an inclined posture suitable for viewing and to avoid the media player from sliding on or falling from his/her thighs thus making it inconvenient to use.

### SUMMARY OF THE INVENTION

The present invention has been accomplished in view of the above noted circumstances. It is therefore one objective of the present invention to provide a portable media player, which can be conveniently adjusted to an inclined posture for viewing.

It is another objective of the present invention to provide a portable media player, which can prevent its sliding on or falling from the user's thighs when it is placed thereon.

To achieve these objectives of the present invention, the portable media player comprises a media playing device, such as a tablet personal computer, a digital picture frame, a portable DVD player or a portable television, and a bag containing a plurality of granular objects therein and fastened to the media playing device. Adjusting the distribution of the granular objects in the bag makes the bag deformable. By means of the profile deformable bag, the media playing device can be conveniently placed in an inclined posture suitable for viewing by the user. In addition, because the profile of the bag is deformable, when the portable media player is placed on user's thighs, the bag can match up the user's thighs, thereby preventing the portable media player from sliding on or falling from the user's thighs.

In an embodiment of the present invention, the bag is firmly fastened to the media playing device by adhesive.

In another embodiment of the present invention, the bag is detachably coupled to the media playing device by a fastener. The fastener can be a magnetic fastener including a magnet mounted on a top side of the bag, and a magnetism-conductive member mounted on a bottom side of the media playing device and attracted by the magnet. Alternatively, the fastener can be a hook and loop fastener including a hook member mounted on a top side of the bag, and a loop member mounted on a bottom side of the media playing device and engaged with the hook member.

Further scope of applicability of the present invention will become apparent firm the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a portable media player according to a first preferred embodiment of the present invention;

FIG. 2 is a cross-sectional view of the portable media player according to the first preferred embodiment of the present invention;

FIG. 3 is similar to FIG. 2 but showing that the media playing device is inclined:

FIG. 4 is a schematic drawing showing that the potable media player is placed on user's thighs;

FIG. 5 is an exploded side view of a portable media player according to a second preferred embodiment of the present invention;

FIG. 6 is an exploded side view of a portable media player according to a third preferred embodiment of the present invention;

FIG. 7 is an assembled side view of the portable media player according to the third preferred embodiment of the present invention, and

FIG. 8 is a schematic drawing showing that the portable media player in accordance with the third preferred embodiment of the present invention is placed on user's thighs.

### DETAILED DESCRIPTION OF THE INVENTION

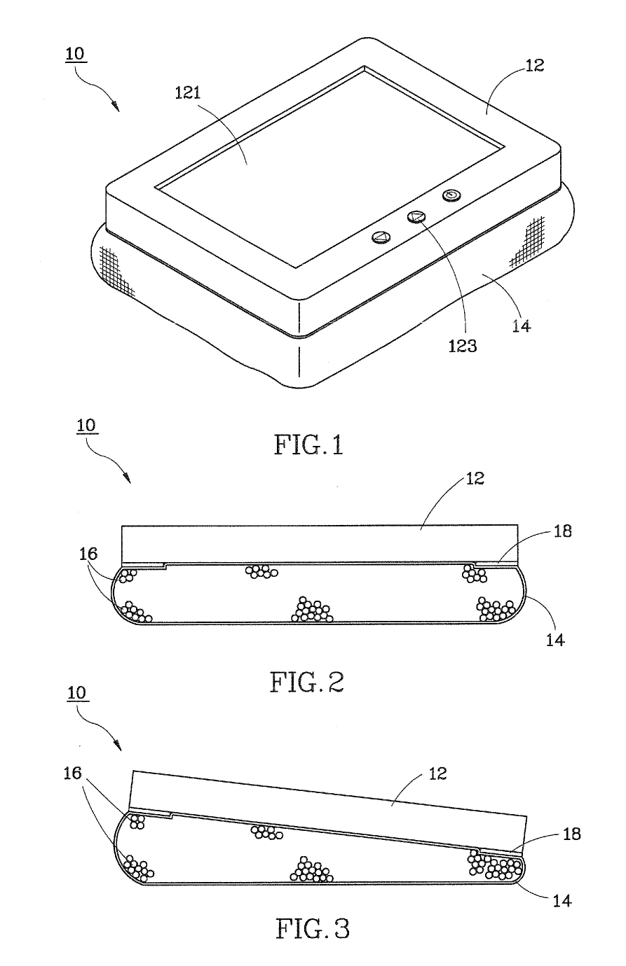

As shown in FIG. 1 and FIG. 2, a portable media player 10 in accordance with a first preferred embodiment of the present invention comprises a media playing device 12, a bag 14 and a plurality of granular objects 16.

The media playing device 12, which is embodied as a rectangular and tabular portable DVD player in this embodiment, is provided at a top side thereof with an LCD screen 121 for showing digital static/dynamic images, and three buttons 123 under the LCD screen 121 for controlling the LCD screen 121. It is to be easily understood that the media playing device 12 can be any suitable media playing device, such as, but not limited to, digital picture frame, tablet PC or a portable TV.

The bag 14 is made of fabrics or any suitable material and fastened to a bottom side of the media playing device 12 by adhesive 18.

The granular objects 16 are stuffed into the bag 14. They can be formed of any suitable objects including but not limited to beans, grains of rice or plastic beads such as polystyrene beads. Since the granular objects 16 make the profile of the bag 14 deformable, the bag 14 can support the media playing device 12 in a desired posture.

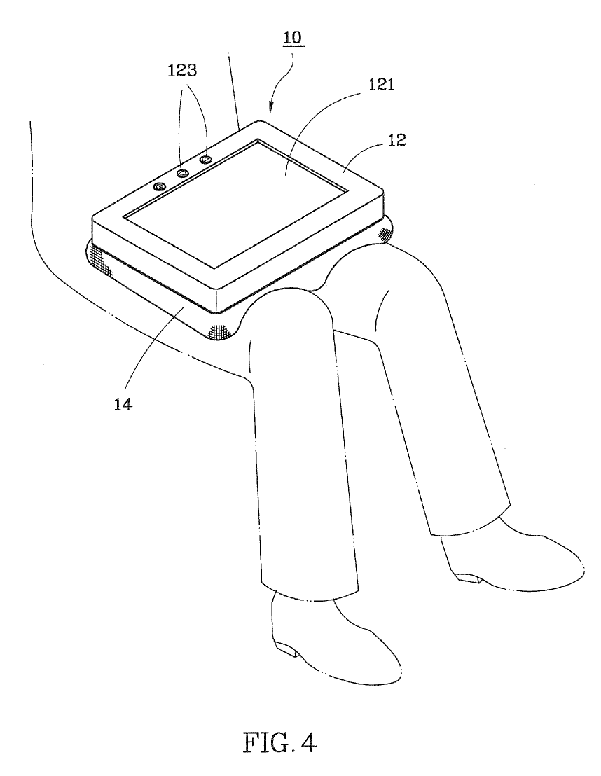

When the media player 10 is placed on user's thighs or on a table, adjusting the distribution of the granular objects 16 in the bag 14 can easily make the media playing device 12 inclined at a specific angle suitable for viewing, as shown in FIG. 3. In other words, the media playing device 12 can be easily adjusted to a specific inclined posture suitable for viewing by means of changing the shape of the bag 14. Further, because of the profile deformable feature of the bag 14 when the media player 10 is placed on user's thighs, the shape of the bag 14 can be changed to match up the user's thighs, as shown in FIG. 4, to increase the contact area between the bag 14 and the user's thighs, resulting in that the friction between the bag 14 and the user's thighs will be increased, thereby avoiding the media player 10 from sliding on or falling from the user's thighs.

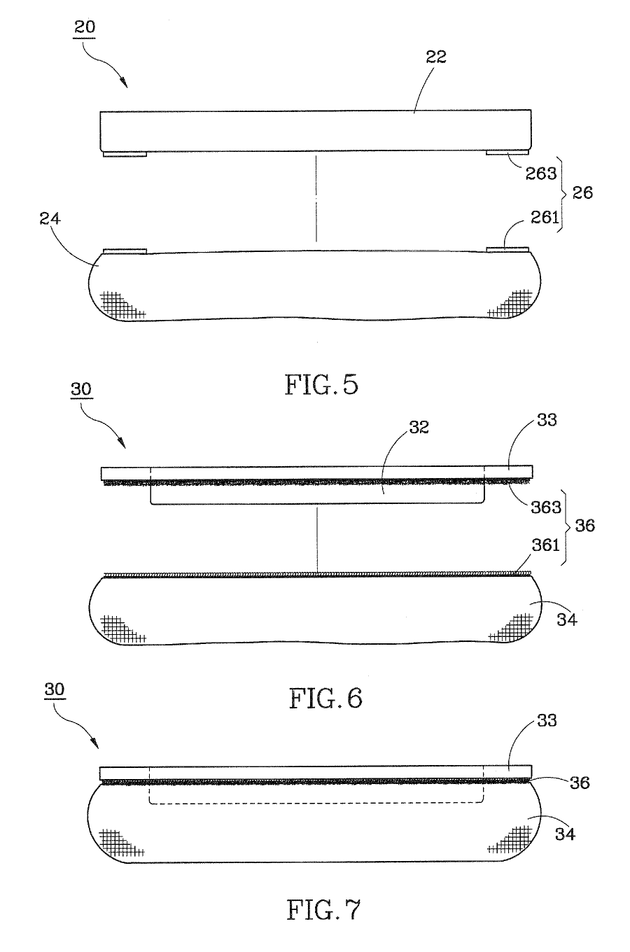

It is to be understood that the way of how the media playing device is fastened to the bag is not limited to the above-mentioned disclosure of the first embodiment. As shown in FIG. 5, a media player 20 in accordance with a second preferred embodiment of the present invention comprises a media playing device 22, a bag 24 containing therein a plurality of granular objects (not shown), and a pair of magnetic fasteners 26. Each fastener 26 includes a magnet 261 mounted on a periphery of a top side of the bag 24 and a magnetism-conductive member 263 mounted on a periphery of the bottom side of the media playing device 22 corresponding to and attractable by the magnet 261. Therefore, the media playing device 22 can be detachably coupled to the bag 24 by the magnetic force.

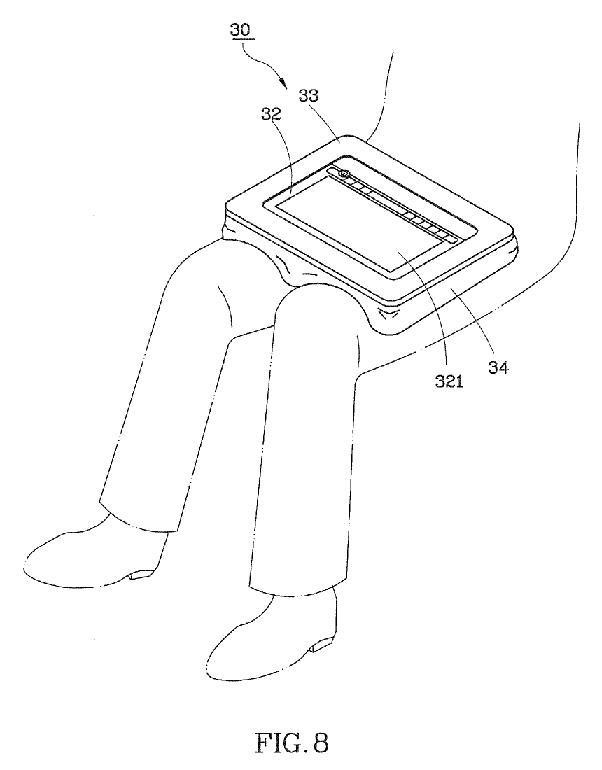

As shown in FIG. 6 to FIG. 8, a media player 30 in accordance with a third preferred embodiment of the present invention has basically the same structure as the second embodiment of the present invention, except that the media playing device 32 further includes a frame 33 on the periphery thereof and a hook and loop fastener is provided between the media playing device 32 and the bags 34. The hook and loop fastener includes a hook member 361 mounted on the periphery of the top side of the bag 34 and a loop member 363 mounted on the periphery of the bottom side of the frame 33 of the media playing device 32 and couplable with the hook member 361. Accordingly, the frame 33 of the media playing device 32 and the bag 34 are detachably coupled to each other through the hook and loop members 361 and 363.

The portable media player can be made with various kinds of design according to the spirit of the present invention. For example, the bag and the media playing device can be fastened to each other by a zipper, screws or rivets.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A portable media player comprising:
a media playing device;
a bag containing a plurality of granular objects therein and fastened to the media playing device.

2. The portable media player as claimed in claim 1, wherein the media playing device is a tablet personal computer, a digital picture frame, a portable DVD player or a portable television.

3. The portable media player as claimed in claim 1, further comprising a fastener for coupling the bag to the media playing device.

4. The portable media player as claimed in claim 3, wherein the fastener includes a magnet mounted on a top side of the bag, and a magnetism-conductive member mounted on a bottom side of the media playing device and attracted by the magnet.

5. The portable media player as claimed in claim 3, wherein the fastener is a hook and loop fastener including a hook member mounted on a top side of the bag, and a loop member mounted on a bottom side of the media playing device and engaged with the hook member.

6. The portable media player as claimed in claim 1, wherein the media playing device has a frame on the periphery thereof for connection with the bag.

7. The portable media player as claimed in claim 1, wherein the bag is fastened to the media playing device by adhesive.
